(19) United States
(12) Patent Application Publication
(10) Pub. No.: US 2017/0056978 A1
(43) Pub. Date: Mar. 2, 2017

(54) Wheel Rim Processing Device

(71) Applicant: Factory Automation Technology CO.,LTD., Chiayi County (TW)

(72) Inventors: PO CHENG SU, Chiayi County (TW); KU TANG CHOU, Chiayi County (TW); ZONG HAN HO, Chiayi County (TW)

(21) Appl. No.: 15/247,891

(22) Filed: Aug. 25, 2016

(30) Foreign Application Priority Data
Aug. 27, 2015 (TW) 104214019

(51) Int. Cl. B23B 41/00; B23Q 3/06

(52) U.S. Cl. CPC B23B 41/00; B23Q 3/062; B23B 2215/08; B23B 2260/03

(57) ABSTRACT

A wheel rim processing device for conducting wheel rim boring process. The wheel rim processing device comprises a base platform, a plurality of locators, a plurality of grippers, and a cutter unit. The base platform allows the wheel rim to be placed thereon and has a central slot hole corresponding to the spoke portion formed thereon and a long slot hole corresponding to the annular portion. The cutter unit can conducting boring process to the spoke portion and the annular portion respectively through the central slot hole and the long slot hole. The scraps generated in the process will fall from the hollow portion of the wheel rim rather than be accumulated on the base platform, which prevents the scraps or residues accumulated on the base platform during the wheel rim positioning process and the boring process.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

1. Field of the Invention

The present invention relates to a wheel rim processing machine, and more particularly to a wheel rim processing device, wherein the base platform is arranged for securely holding the wheel rim by a three-point positioning configuration to position a center of the wheel rim and is movable for adjusting the wheel rim at different positions and angles during the boring process.

2. Description of Related Arts

Current vehicle wheel rim processing industries have evolved to have a all-in-one rim processing machine to perform multiple processes in order to shorten the manufacturing time as well as lower the producing cost. For example, Taiwan Patent No. 101224211: “Wheel Rim Processing Machine,” Taiwan Patent No. 97133540: “Processing Method of Wheel Rim,” China Patent No. 200480043493.1, and U.S. Pat. No. 392550 disclosed different revealed technical knowledge regarding the wheel rim processing. Accordingly, Taiwan Patent No. 101224211 disclosed the “Wheel Rim Processing Machine”, wherein the machine comprises a clamp set and a main shaft cutting tool. The wheel rim is clamped by the clamp set to retain the position of the wheel rim in a rotatable manner, wherein the main shaft cutting tool will perform a boring process on the wheel rim. In particular, this machine can make PCD holes, valve holes, and heat dissipation holes on the wheel rim, such that this machine can be considered to perform multiple processes for the wheel rim. However, the major drawback of this machine is that the residues are produced during the boring process and are easily left on the clamp set for affecting the wheel rim positioning process. As a result, when the clamp set retains the next wheel rim, the position of the next wheel rim will be inaccurately. In other words, once the wheel rim is retained at an inaccurate position, the holes will be inaccurately formed on the wheel rim.

### SUMMARY OF THE PRESENT INVENTION

Therefore, an object of the present invention is to provide a wheel rim processing device that is able to prevent the scraps or residues accumulated at the wheel rim during the wheel rim positioning process and the boring process.

According to the present invention, the foregoing and other objects and advantages are attained by a wheel rim processing device for a wheel rim having an annular portion, a spoke portion, and a plurality of positioning slots provided at a rim of the annular portion, wherein the wheel rim processing device comprises a base platform, a plurality of locators, a plurality of grippers, and a cutter unit. The base platform has a first side, an opposed second side, a central through hole, and an elongated through slot, wherein the base platform is arranged for supporting the wheel rim on the first side at a position that the spoke portion of the wheel rim is aligned with the central through hole of the base platform and the annular portion wheel rim is aligned with the elongated through hole. The locators are coupled at the first side of the base platform and are positioned radially with respect to the central through hole, wherein the locators are arranged for engaging the positioning slots respectively to position a center of the wheel rim. The grippers are coupled at the first side of the base platform for gripping the annular portion of the wheel rim, wherein the grippers are positioned radially with respect to the central through hole alternating with the locators. The cutter unit is actuated for performing a boring process to the spoke portion and the annular portion of the wheel rim through the central through hole and the elongated through slot from the second side of the base platform to the first side of the base platform. During the wheel rim boring process, the wheel rim will be securely positioned on the first side of the base platform through the locators and grippers. The cutter unit is actuated to perform the boring process to the spoke portion and the annular portion of the wheel rim respectively through the central through hole and the elongated through slot. Since the cutter unit is actuated from the second side of the base platform to the first side thereof, the scraps or residues generated in the boring process will fall from the hollow portion of the wheel rim rather than being accumulated on the base platform, which prevents the scraps or residues accumulated at the wheel rim or on the base platform during the wheel rim positioning process and the boring process.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of the wheel rim processing device according to a preferred embodiment of the present invention.

FIG. 2 is a partially exploded view of the wheel rim processing device according to the above preferred embodiment of the present invention.

FIG. 3 is an exploded perspective view of a locator of the wheel rim processing device according to the above preferred embodiment of the present invention.

FIG. 4 is a partially sectional view of the wheel rim processing device according to the above preferred embodiment of the present invention.

FIG. 5 is a partially sectional view of the wheel rim processing device according to the above preferred embodiment of the present invention illustrating the movement of the locator.

FIG. 6 is a perspective view of the wheel rim processing device according to the above preferred embodiment of the present invention illustrating a first position thereof.

FIG. 7 is a perspective view of the wheel rim processing device according to the above preferred embodiment of the present invention illustrating a second position thereof.

### DETAILED DESCRIPTION OF THE PREFERRED EMBODIMENT

The following description is disclosed to enable any person skilled in the art to make and use the present invention. Preferred embodiments are provided in the following description only as examples and modifications will be apparent to those skilled in the art. The general principles defined in the following description would be applied to other embodiments, alternatives, modifications, equivalents, and applications without departing from the spirit and scope of the present invention.

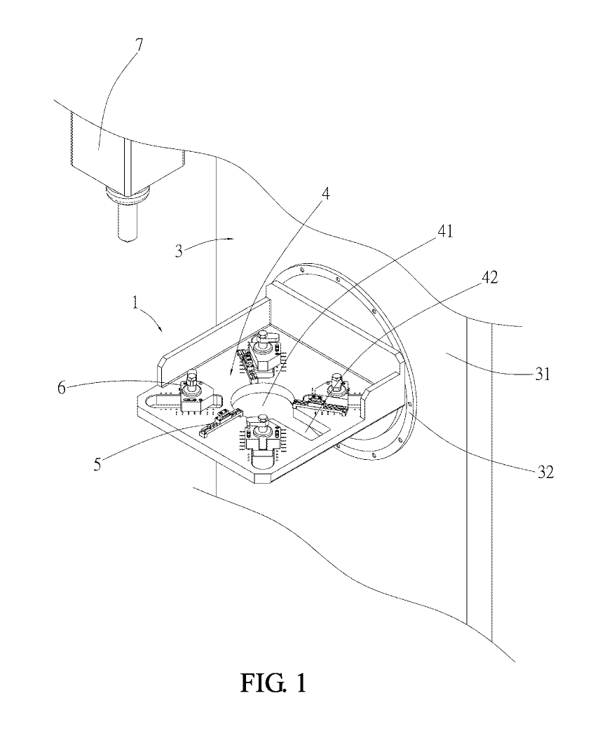

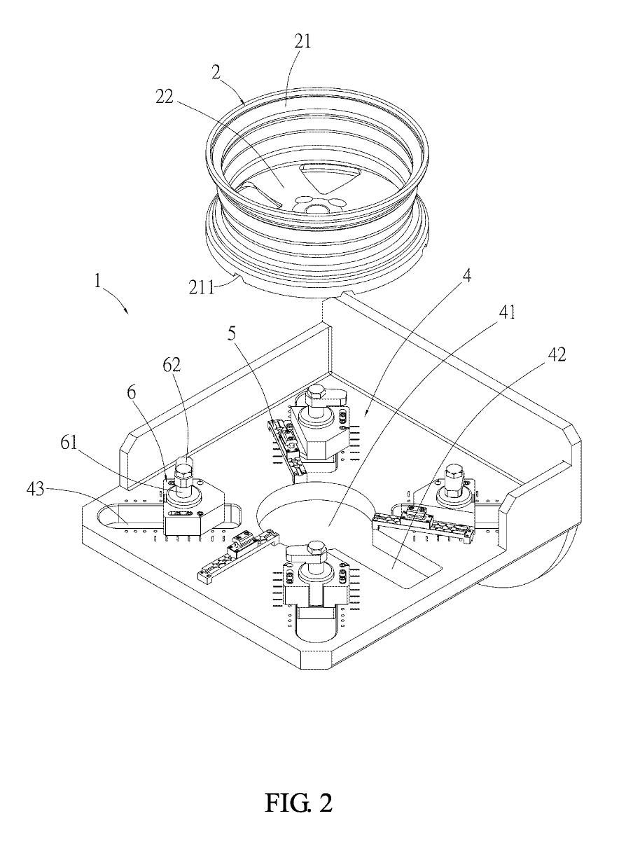

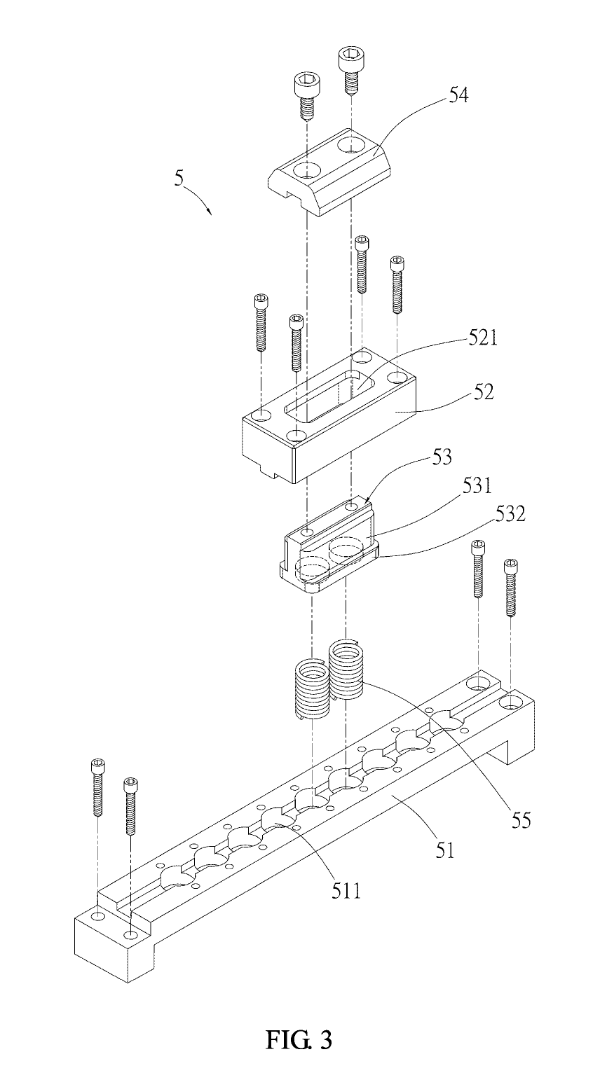

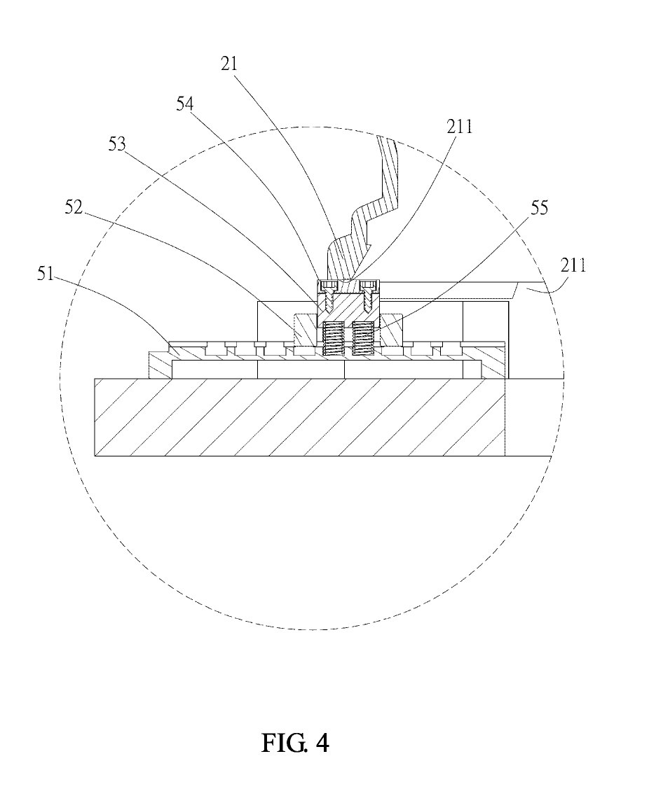

Referring to FIGS. 1 to 4 of the drawings, a wheel rim processing device 1 according to a preferred embodiment of the present invention is illustrated, wherein the wheel rim processing device 1 is arranged for performing a boring process for a wheel rim 2. The wheel rim 2 has an annular portion 21 and a spoke portion 22 integrally and inwardly extended from the annular portion 21. A rim of the annular portion 21 of the wheel rim 2 has a plurality of positioning slots 211, preferably six, with evenly interval between every two of the positioning slots 211. The wheel rim processing device 1 comprises a rotation unit 3, a base platform 4, a plurality of locators 5, a plurality of grippers 6, and a cutter unit 7. Preferably, there are three locators 5 and four grippers 6.

The rotation unit 3 comprises a body 31 and a turntable 32 assembled on the body 31. The turntable 32 is rotatably coupled on the body 31.

The base platform 4 is coupled to the turntable 32 at a position that the wheel rim 2 is supported on the base platform 4, wherein the base platform 4 is driven to rotate by the turntable 32. The base platform 4 has a central through hole 41 formed thereon coaxially aligned with a position of the spoke portion 22 of the wheel rim 2, an elongated through slot 42 communicatively and radially extended from the central through hole 41 corresponding to the annular portion 21 of the wheel rim 2, and a plurality of shifting through slots 43 radially extended with respect to the central through hole 41 towards corners of the base platform 4. In other words, every two shifting through slots 43 are formed in pair, the shifting through slots 43 in each pair are aligned with each other end-to-end along a diagonal of the base platform 4. Accordingly, the elongated through slot 42 is extended from the central through hole 41 to form a key-hole configuration.

The locators 5 are coupled on a first side of the base platform 4 and radially positioned with respect to the central through hole 41. Each locator 5 comprises a fixing base 51 secured on the base platform 4, a frame cover 52 locked on the fixing base 51, a shifting element 53 assembled inside of the frame cover 52, a positioning member 54 secured above the shifting element 53, and two resilience elements 55. The fixing base 51 has a plurality of spacing grooves 511 alignedly connected with each other. The frame cover 52 has an elongated stretching slot 521 formed along a centerline of the frame cover 52. The shifting element 53 has a protruding portion 531 and an enlarged resisting portion 532 sidewardly and outwardly extended from a bottom of the protruding portion 531. The protruding portion 531 can pass the stretching slot 521, while the resisting portion 532 cannot because a size of the resisting portion 532 is larger than a size of the stretching slot 521. Therefore, the movement of the shifting element 53 is limited inside of the frame cover 52. The positioning member 54 is engaged in the corresponding positioning slot 211. The two resilience elements 55 are optionally applied in corresponding spacing groove 511 according to different specifications of the wheel rims 2. The two resilience elements 55 are biased between the fixing base 51 and the shifting element 53 to keep the protruding portion 531 of the shifting element 53 protruding out from the frame cover 52.

The grippers 6 are respectively arranged in the shifting through slots 43 of the base platform 4 at the first side thereof for gripping the annular portion 21 of the wheel rim 2. The grippers 6 are radially positioned with respect to the central through hole 41, wherein the grippers 6 and the locators 5 are positioned alternating with each other. Each gripper 6 has a positioning shaft 61 movable in an up-and-down manner and in a rotatable manner, and a gripping member 62 transversely extended from one end of the positioning shaft 61. When the wheel rim 2 is positioned, the positioning shaft 61 is actuated to move downwardly and to rotate until the gripping member 62 grips the annular portion 21 of the wheel rim 2. The gripping structure of the gripper 6 is known that there will not be detail description with relative figure thereof. It is worth mentioning that the position of each gripper 6 in the shifting through slot 43 is adjustable, so as to coordinate with wheel rim 2 with different sizes and specifications.

The cutter unit 7 is a cutting tool for boring and tapping. It can perform a boring process to the spoke portion 22 and the annular portion 21 respectively through the central through hole 41 and the elongated through slot 42 from an opposed side of the base platform 4 to the first side thereof. Besides, it can further utilize tapping cutting tool to tap the holes into screw holes after the boring process is finished.

Before processing the wheel rim 2, the wheel rim 2 is held to align with the locators 5 by an external mechanism. When positioning, the positioning slots 211 of the wheel rim 2 are correspondingly coupled with the positioning members 54 of the locators 5. Therefore, the wheel rim 2 is held by a three-point positioning configuration with respect to the center of the wheel rim 2 without requiring other supplementary positioning device. The positioning procedure of the present invention is simple and easy to operation.

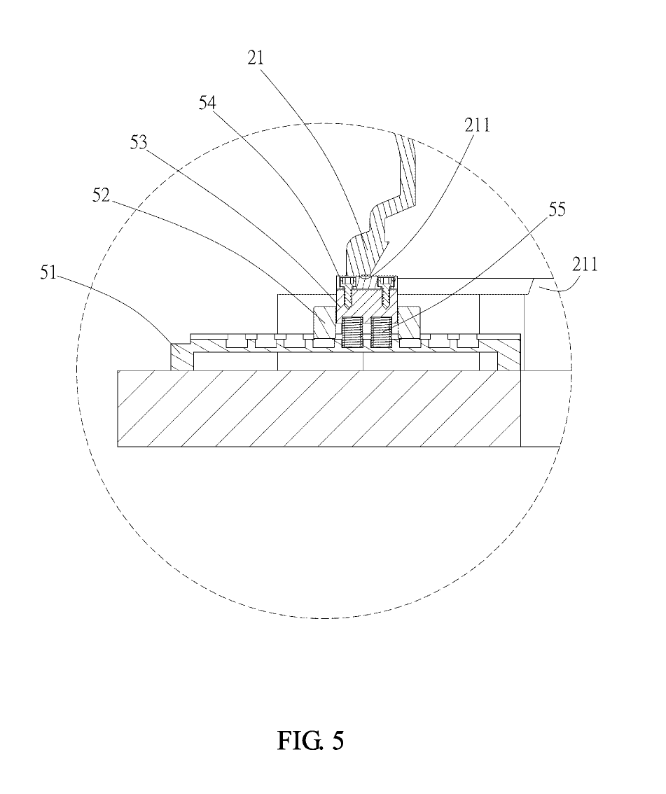

Accordingly, the grippers 6 grip the annular portion 21 of the wheel rim 2 at the same time. The annular portion 21 will immediately press down the positioning members 54, the shifting element 53, and the two resilience elements 55, as shown in FIG. 5, so as to accurately position the wheel rim 2 on the base platform 4.

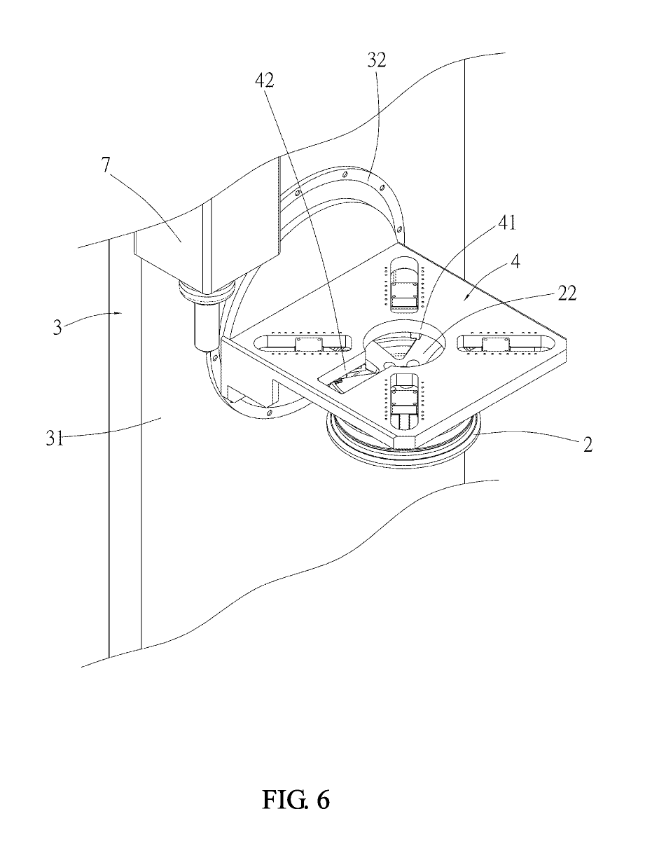

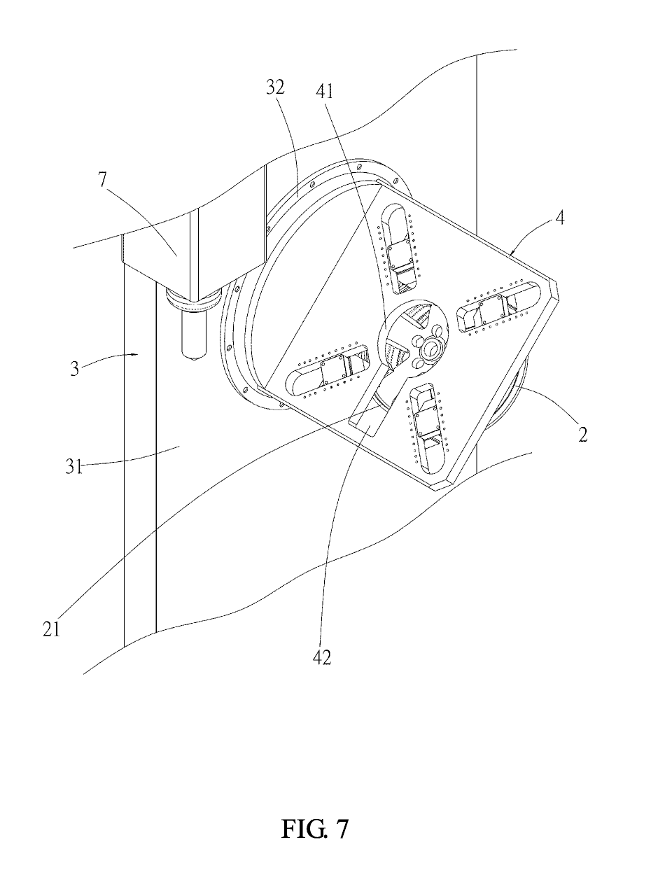

Referring to FIG. 6, for performing the boring process to the spoke portion 22 of the wheel rim 2, the turntable 32 of the rotation unit 3 is firstly rotated to move the base platform 4 to rotate for 180 degrees until the second side of the base platform 4 is located above the first side thereof, so that the base platform 4 is located above the wheel rim 2. In other words, the second side of the base platform 4 faces towards the cutter unit 7 while the wheel rim 2 is held at the first side of the base platform 4. Meanwhile, the cutter unit 7 is actuated to extend through the central through hole 41 from the second side of the base platform 4 to perform the boring process to the spoke portion 22 of the wheel rim 2. Then, the rotation unit 3 can further rotate for 45 degrees, as shown in FIG. 7, so that the cutter unit 7 is actuated to extend through the elongated through slot 42 from the second side of the base platform 4 to perform the boring process to the annular portion 21 of the wheel rim 2. The holes serves as valve holes of the wheel rim 2. Besides, the holes formed at the spoke portion 22 by the cutter unit 7 are not just common PCD holes. Rather, screw holes can also be formed at other positions of the spoke portion 22 for locking other device. That is to say, the wheel rim processing device 1 is able to make PCD holes, valve holes, and screw holes on the wheel rim 2, so as to achieve the effect of a multi-function machine.

Based on the above description, whether the boring process is performed at the spoke portion 22 or the annular portion 21, the wheel rim 2 is positioned below the base platform 4, such that the scraps or residues generated during the boring processing will fall from the hollow of the wheel rim 2 immediately instead of remaining on the base platform 4. Therefore, the base platform 4 can be kept clear. Also, it does not require an additional process of base platform 4 cleaning in the overall process. The positioning of the wheel rim 2 will not be affected with its accuracy due to the scraps or residues as well. Hence, the processing accuracy will not be affected. All in all, the present invention can achieve the effects of reliably removing the scraps, further shortening the processing hour, and ensuring the processing accuracy.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A wheel rim processing device for a wheel rim having an annular portion, a spoke portion, and a plurality of positioning slots provided at a rim of the annular portion, wherein said wheel rim processing device comprises:
a base platform having a first side, an opposed second side, a central through hole, and an elongated through slot, wherein said base platform is arranged for supporting the wheel rim on said first side at a position that the spoke portion of the wheel rim is aligned with said central through hole of said base platform and the annular portion wheel rim is aligned with said elongated through hole;
a plurality of locators coupled at said first side of said base platform and positioned radially with respect to said central through hole, wherein said locators are arranged for engaging the positioning slots respectively to position a center of the wheel rim;
a plurality of grippers coupled at said first side of said base platform for gripping the annular portion of the wheel rim, wherein said grippers are positioned radially with respect to said central through hole; and
a cutter unit being actuated for performing a boring process to the spoke portion and the annular portion of the wheel rim through said central through hole and said elongated through slot from said second side of said base platform to said first side of said base platform.

2. The wheel rim processing device, as recited in claim 1, wherein said locators and said grippers are coupled on said first side of said base platform that said locators are positioned alternating with said grippers.

3. The wheel rim processing device, as recited in claim 1, further comprising a rotation unit coupled to said base platform to move said base platform in a rotatable manner.

4. The wheel rim processing device, as recited in claim 4, further comprising a rotation unit coupled to said base platform to move said base platform in a rotatable manner.

5. The wheel rim processing device, as recited in claim 3, wherein said rotation unit comprises a body and a turntable rotatably coupled on said body, wherein said base platform is coupled to said turntable, such that when said turntable is rotated at said body, said base platform is driven to rotate correspondingly.

6. The wheel rim processing device, as recited in claim 4, wherein said rotation unit comprises a body and a turntable rotatably coupled on said body, wherein said base platform is coupled to said turntable, such that when said turntable is rotated at said body, said base platform is driven to rotate correspondingly.

7. The wheel rim processing device, as recited in claim 1, wherein each of said locators comprises a positioning member movably coupled at said first side of said base platform in an up-and-down manner for engaging with the positioning slot of the wheel rim.

8. The wheel rim processing device, as recited in claim 6, wherein each of said locators comprises a positioning member movably coupled at said first side of said base platform in an up-and-down manner for engaging with the positioning slot of the wheel rim.

9. The wheel rim processing device, as recited in claim 7, wherein each of said locators further comprises a fixing base secured on said base platform, a frame cover locked on said fixing base, a shifting element movably coupled at said frame cover, and at least a resilience element biased between said fixing base and said shifting element, wherein said positioning member is secured above said shifting element.

10. The wheel rim processing device, as recited in claim 8, wherein each of said locators further comprises a fixing base secured on said base platform, a frame cover locked on said fixing base, a shifting element movably coupled at said frame cover, and at least a resilience element biased between said fixing base and said shifting element, wherein said positioning member is secured above said shifting element.

11. The wheel rim processing device, as recited in claim 9, wherein said frame cover has an elongated stretching slot formed along a centerline of said frame cover, wherein said shifting element has a protruding portion movable in said stretching slot and a resisting portion extended from said protruding portion, wherein a size of said resisting portion is larger than a size of said stretching slot so as to limit said shifting element in said frame cover.

12. The wheel rim processing device, as recited in claim 11, wherein said frame cover has an elongated stretching slot formed along a centerline of said frame cover, wherein said shifting element has a protruding portion movable in said stretching slot and a resisting portion extended from said protruding portion, wherein a size of said resisting portion is larger than a size of said stretching slot so as to limit said shifting element in said frame cover.

13. The wheel rim processing device, as recited in claim 1, wherein said base platform further has a plurality of shifting through slots radially extended with respect to the central through hole, wherein said grippers are respectively arranged in corresponding said shifting through slots, such that positions of said grippers are adjustable in said shifting through slots.

14. The wheel rim processing device, as recited in claim 12, wherein said base platform further has a plurality of shifting through slots radially extended with respect to the central through hole, wherein said grippers are respectively arranged in corresponding said shifting through slots, such that positions of said grippers are adjustable in said shifting through slots.

15. The wheel rim processing device, as recited in claim 1, wherein said elongated through slot is communicatively extended from said central through hole to form a key-hole configuration.

16. The wheel rim processing device, as recited in claim 14, wherein said elongated through slot is communicatively extended from said central through hole to form a key-hole configuration.

17. The wheel rim processing device, as recited in claim 1, wherein said base platform is rotated at a position that said second side of said base platform is located above said first side thereof when said cutter unit is actuated for performing said boring process.

18. The wheel rim processing device, as recited in claim 16, wherein said base platform is rotated at a position that said second side of said base platform is located above said first side thereof when said cutter unit is actuated for performing said boring process.

19. The wheel rim processing device, as recited in claim 1, wherein each of said grippers comprises a positioning shaft movably coupled at said first side of said base platform in an up-and-down manner and in a rotatable manner, and a gripping member transversely extended from one end of said positioning shaft, wherein said positioning shaft is moved downwardly and rotated for coupling said gripping member at the annular portion of the wheel rim.

20. The wheel rim processing device, as recited in claim 18, wherein each of said grippers comprises a positioning shaft movably coupled at said first side of said base platform in an up-and-down manner and in a rotatable manner, and a gripping member transversely extended from one end of said positioning shaft, wherein said positioning shaft is moved downwardly and rotated for coupling said gripping member at the annular portion of the wheel rim.
